(19) United States
(12) Patent Application Publication
(10) Pub. No.: US 2014/0306880 A1
(43) Pub. Date: Oct. 16, 2014

(54) METHOD AND CONTROL DEVICE TO OPERATE A MEDICAL DEVICE IN A STERILE ENVIRONMENT

(71) Applicant: Siemens Aktiengesellschaft, Muenchen (DE)

(72) Inventors: Peter Greif, Pinzberg/Gosberg (DE); Anja Jaeger, Fuerth (DE); Robert Kagermeier, Nuernberg (DE)

(73) Assignee: SIEMENS AKTIENGESELLSCHAFT, Muenchen (DE)

(21) Appl. No.: 14/250,512

(22) Filed: Apr. 11, 2014

(30) Foreign Application Priority Data
Apr. 12, 2013 (DE) 102013206553.1

(51) Int. Cl. G06F 3/01

(52) U.S. Cl. CPC G06F 3/011; G06F 3/017
USPC 345/156

(57) ABSTRACT

In a method and an apparatus for operating a controlled device in a sterile environment, a receiver detects contact-free user inputs respectively made by different users. A first operating mode of the receiver is activated after detection of an arbitrary contact-free user input of any of said users. The receiver is switched from the first operating to a second operating mode after detecting a predetermined contact-free user input. Upon switching from the first operating mode into the second operating mode, the predetermined contact-free user input can be made only by the user who last made a contact-free user input in the first operating mode. An additional operating mode can be activated under predetermined conditions.

### BACKGROUND OF THE INVENTION

1. Field of the Invention

The invention concerns methods to operate a device in a sterile environment, as well as a device suitable for use in a sterile environment.

2. Description of the Prior Art

In interventional medicine, it frequently occurs that a physician would like to retrieve information from patient documents or archived images during an operation. Such actions can take place in a sterile OP area only with operating elements that have been elaborately covered beforehand with films. This procedure takes a great deal of time that the patient must continue to spend under anesthesia, and involves an increased risk of transferring germs from the contacted surfaces. In such sterile environments, it is possible to use devices that can be controlled without contact, such as with the aid of gestures or speech.

Given an application based on gestures, it is disadvantageous that many different gestures are required respectively for a number of operating functions, and these gestures must initially be learned by a user. Moreover, for some processes a two-handed gesture is necessary, which is not always possible in the interventional environment. For example, for workflows that require a repeated execution of a swiping gesture—such as leafing through 100 pages—a gesture operation is likewise not reasonable.

In DE 102013201527.5, a method is disclosed for retrieving and controlling data and/or archived images in a sterile environment via a target system. In this method a speech command to select an operating mode, is made and an operating mode corresponding to the speech command is identified. The selected operating mode is activated. A gesture command is then made to scale the selected operating mode. The gesture command is detected and the operating mode is scaled based on the gesture command.

This method is based on the assumption that the employed speech control will achieve a high recognition rate with low error rate. In addition, an omnidirectional microphone should be used so that the speech control can be provided with optimally little effort by the user, and the user is not hindered in his or her actual activity by a headset or stage microphone, and requires additional preparation time.

All environment noises affect such an omnidirectional microphone. This means that the actual speech command must be filtered out and correctly interpreted. A complicated noise suppression that filters the interfering noises out of the signal must be executed beforehand.

An additional possibility is the use of a microphone array that automatically matches the microphone sensitivity or aligns the lobe (i.e., the primary or strongest lobe of the reception pattern) of the microphone array on the active acoustic source, but interfering noises or other speech can interfere with the automatic alignment.

### SUMMARY OF THE INVENTION

An object of the invention is to provide a method and a device for improved operation in a sterile environment.

A method in accordance with the invention to operate a device in a sterile environment, which is controlled via at least one receiver device to detect contact-free user inputs that can be made by different users has the following steps.

A first operating mode of the device is activated after detection of an arbitrary contact-free user input of any user. A switch from the first operating mode to a second operating mode of the device occurs after detecting a predetermined contact-free user input from one of the users. After switching from the first operating mode into the second operating mode, the device will accept the aforementioned predetermined contact-free user input only if it is made by the user who has last made a contact-free user input in the first operating mode.

Such a predetermined user input can be a “Track me” speech command or a gesture in which he holds a hand still at head height for a few seconds.

An additional operating mode (Z0) of the device is initially activated after detection of an inactive phase of user inputs and/or after detection of an additional predetermined, contact-free user input of the user who has previously made the predetermined user input in b). A selection thus can be made between the predetermined user input “Stop tracking” and a stop gesture.

A switch from the additional operating mode into the second operating mode of the device can be made after detection of a predetermined contact-free user input, which can input by the first or a second user.

In the first operating mode, the alignment of the receiver device on one of the users to detect his contact-free user inputs can be set, wherein a change of the alignment from the first user to the second user, and vice versa, is possible in this operating mode.

The change of the alignment of the receiver device can be time-controlled. For example, the alignment from the first user to the second user can be changed if the first user is silent for more than 3 seconds, for example, or if the second user speaks or makes a gesture within 3 seconds after the last speech by the first user.

In the second operating mode, the alignment of the receiver device can be set or focused on only one user to detect his or her contact-free user inputs, wherein a change of the alignment from the first user to the second user and vice versa is precluded in this operating mode. In other words: only one user perpetually has focus.

In a further operating mode, the alignment of the receiver device can initially be set to none of the users to detect a contact-free user input.

The at least one receiver device can be a camera, a TOF camera, a head tracker, an eye tracker and/or a microphone.

In an embodiment of the invention, the receiver device is designed to detect hand gestures, arm gestures, head gestures, eye gestures and/or speech inputs as contact-free user inputs.

The invention also encompasses a control device (interface) for operating a medical device, the control device having at least one receiver that detects contact-free user inputs, which can be made respectively by different users. The control device is suitable for use in a sterile environment, and includes a mode setting unit that activates a first operating mode of the control device after detecting an arbitrary contact-free user input of any of the users. The mode setting unit switches from the first operating mode to a second operating mode of the control device after detecting a predetermined contact-free user input. After switching from the first operating mode into the second operating mode, the control device will accept the aforementioned predetermined contact-free user input only if it is made by the user who has last made a contact-free user input in the first operating mode.

An additional operating mode of the device can be activatable after detecting an inactive phase of user inputs and/or after detecting an additional predetermined, contact-free user input of the user who has previously made the predetermined user input in b).

A device according to the invention is suitable to execute the method according to the invention. The components of the device according to the invention can be fashioned in software and/or firmware and/or hardware.

All of the described components of the device can also be integrated into a single unit or device.

In an embodiment of the device according to the invention it is designed to operate a medical technology apparatus.

The invention guarantees a good detection rate, independent of where the user stands and what noises interfere with the signal. The alignment of the receiver device (for example a lobe of a microphone array) enables a particular accentuation of the voice of the active user while all environment noises are suppressed.

Moreover, the application of the proposed approach makes the user markedly more flexible: it remains open to each user whether he would like to use a user focusing without changing the user, or whether a fast change of the active user is preferred.

The user comfort for the operator is increased via the invention. It is advantageous that only a limited number of gestures or, respectively, speech commands must be learned in order to specify the processes. All processes occur without contact; even the speech control can operate with an omnidirectional microphone so that a user does not need to route additional cables with him or her that limit his freedom of movement.

The invention also offers the advantage that, given use of gestures and speech, a new, flexible operating concept is achieved via their close interaction so that the work in the operating room is markedly simplified.

However, it is also conceivable that the procedure according to the invention is implemented only with speech control or only with gesture control.

### BRIEF DESCRIPTION OF THE DRAWINGS

FIG. 1 schematically illustrates user focusing in accordance with the invention, wherein the active or focused user is indicated to the user with a screen overlay,

FIG. 2 shows an example of workflow for user focusing in accordance with the invention, with regard to state transitions in an example for two users X and X+1.

FIG. 3 is a block diagram of an exemplary embodiment of a control device in accordance with the present invention.

### DESCRIPTION OF THE PREFERRED EMBODIMENTS

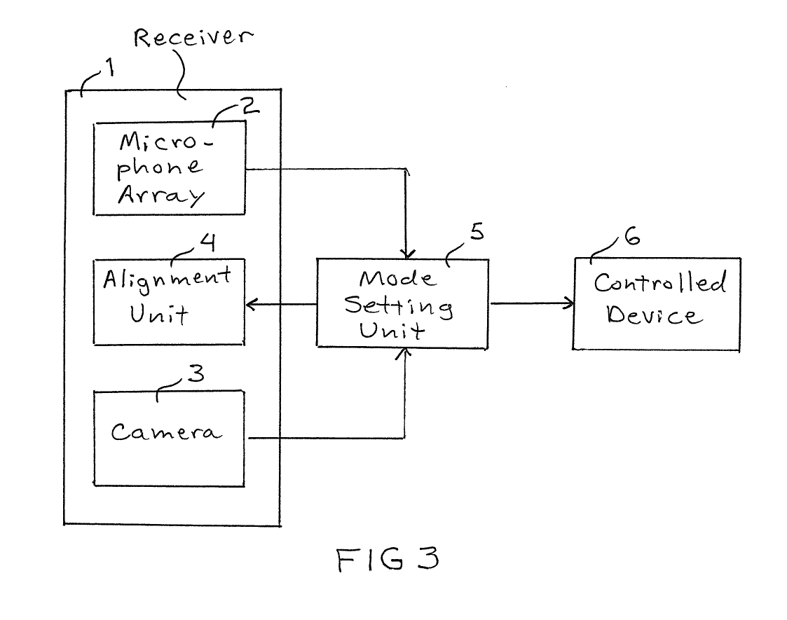

As shown in FIG. 3, a control device 5, such as a medical apparatus, can be used with a receiver 1 for speech and/or gesture detection. The receiver 1 can include a microphone array 2, and a camera 3. The image detected by the camera 3 can be processed (analyzed) automatically to operate an alignment unit 4 such as to align the microphone lobe on a user. In the following, a user focusing is discussed if the microphone lobe and/or the camera remains aligned on a user (X, for example). In other words: the noises from other users (X+1 or other users, for example) are suppressed in the camera image or are not considered in the detection of contact-free user inputs, for example speech or gestures.

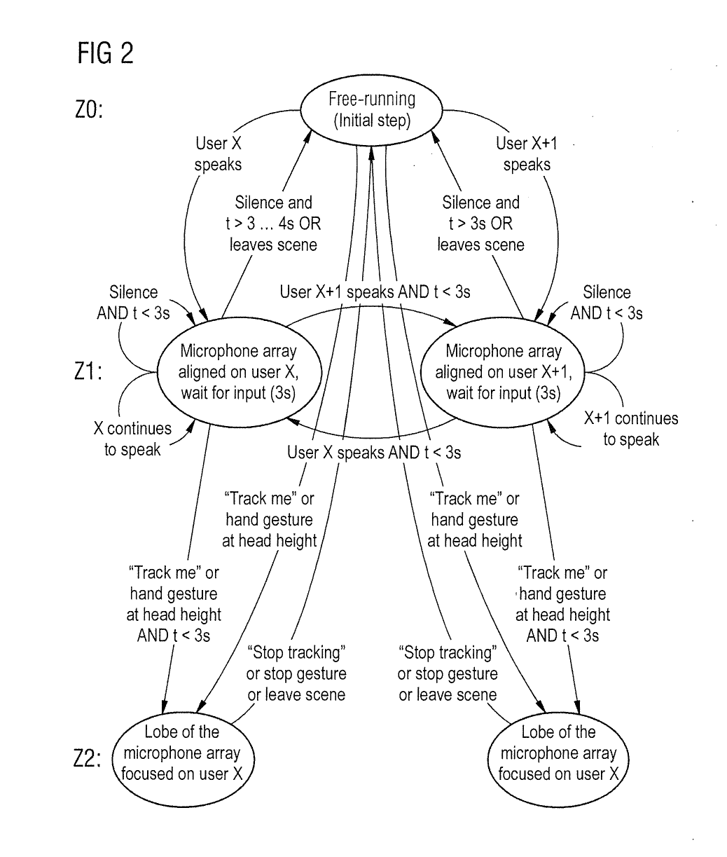

A mode setting unit 5 differentiates three different states or operating modes that are labeled with Z0, Z1 and Z3 in FIG. 2.

Z0: “Free-running”: no user (for example a speaker) has the focus, all noises are acquired (initial step).

Z1: The lobe of the microphone array is aligned on a defined user, which means that the other environment noises are suppressed but the user is not focused (this is not tracked with camera assistance).

Z2: The lobe of the microphone array is focused on a defined user, which means that the other environment noises are suppressed and the lobe of the microphone array will track the used based on the camera so that the focus is perpetually aligned on the user.

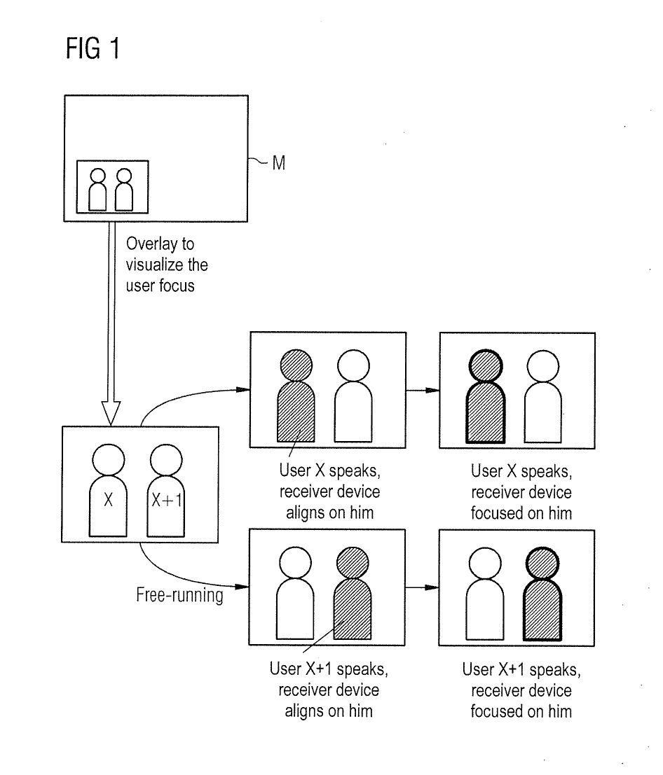

Initially, none of the users has the focus; all noises are uniformly (non-preferentially) acquired and processed further. In order to arrive at the second state or, respectively, operating mode Z1, it is sufficient to speak a few words. The microphone array is automatically aligned according to the loudest acoustic source. The system remains in this state as long as the user continues to speak, or as long as a time window t of 3 seconds has not yet expired. If no additional noise is detected, the system returns back to the original state Z0. If another user begins to speak before the 3 seconds have elapsed, the alignment of the lobe of the microphone array changes to the respective user. On which user it is currently aligned becomes clear with a small overlay on at least one of the provided monitor M, wherein (as shown in FIG. 1) the active user can be distinguished in color from the other detected users.

So that the third state Z2—in which a very concrete user continuously has the focus—can be achieved, a user input via speech (for example “Track me”) or via gesture is required in that the user quietly holds his or her hand at head height for a few seconds, for example “reports”. If continuous focus is granted, the user can move freely. The camera tracks the movement and aligns the lobe of the microphone array corresponding to the location of the focused user. This state can be indicated in the monitor overlay via a thicker colored border.

A new speech or gesture input will take place in order to deselect the focus again, for example because the procedure has ended or in order to enable another user to operate. A selection can thereby be made between the “Stop tracking” command and a stop gesture. The focus is then lost as soon as the user leaves the reception range or the field of view of the camera.

Although modifications and changes may be suggested by those skilled in the art, it is the intention of the inventors to embody within the patent warranted hereon all changes and modifications as reasonably and properly come within the scope of their contribution to the art.

We claim as our my invention:

1. A method to operate a controlled device in a sterile environment, comprising:
with a receiver of an interface device, detecting contact-free user inputs respectively made by different users;
in a computerized mode setting unit connected to said receiver, generating control signals for said controlled device respectively corresponding to said user inputs, and emitting said control signals in electronic form in a format usable by said controlled device to control operation thereof;
in said mode setting unit, activating a first operating mode of said receiver after detection of an arbitrary contact-free user input made by one of said users; and
via said mode setting unit, automatically switching said receiver from said first operating mode to a second operating mode upon said receiver detecting a predetermined contact-free user input and, after switching from said first operating mode into said second operating mode, permitting said receiver to receive said predetermined contact-free user input only when made by said one of said users who last made a contact-free user input in said first operating mode.

2. A method as claimed in claim 1 comprising, via said mode setting unit, activating an additional operating mode of said receiver after detection of at least one of an inactive phase in which no user input is detected, and after detection of an additional predetermined, contact-free user input by said one of said users who previously made said predetermined user input.

3. A method as claimed in claim 2 comprising, via said mode setting unit, switching said receiver from said additional operating mode into said operating mode upon detection of another predetermined contact-free user input made by any of said users.

4. A method as claimed in claim 1 wherein said receiver is alignable, and comprising, in said first operating mode, controlling alignment of said receiver device from said mode setting unit to align said receiver on one of said users in said first operating mode, and changing alignment of said receiver from said one of said users to another of said users in said first operating mode.

5. A method as claimed in claim 4 comprising also changing alignment of said receiver in said first operating mode from said another of said users back to said one of said users.

6. A method as claimed in claim 4 comprising controlling said alignment of said receiver in a time-dependent manner.

7. A method as claimed in claim 1 wherein said receiver is alignable, and controlling alignment of said receiver via said mode setting unit to focus said receiver on only one of said users, and precluding a change of alignment of said receiver off of said one of said users in said second operating mode.

8. A method as claimed in claim 1 wherein said receiver is alignable, and controlling said receiver said mode setting unit to align said receiver on no individual one of said users in said first operating mode.

9. A method as claimed in claim 1 comprising employing, as said receiver, at least one of a camera, a TOF camera, a head tracker, an eye tracker, and a microphone.

10. A method as claimed in claim 1 comprising configuring said receiver to detect, as said contact-free user inputs, inputs selected from the group consisting of hand gestures, arm gestures, head gestures, eye gestures and speech, and comprising configuring said mode selling unit to interpret said input selected from said group in order to generate said control signals therefrom.

11. An apparatus to operate a controlled device in a sterile environment, comprising:
an interface device comprising a receiver that detects contact-free user inputs respectively made by different users;
a computerized mode setting unit connected to said receiver, configured to generate control signals for said controlled device respectively corresponding to said user inputs, and emitting said control signals in electronic form in a format usable by said controlled device to control operation thereof;
said mode setting unit being configured to activate a first operating mode of said receiver after detection of an arbitrary contact-free user input made by one of said users; and
said mode setting unit being configured to automatically switch said receiver from said first operating mode to a second operating mode upon said receiver detecting a predetermined contact-free user input and, after switching from said first operating mode into said second operating mode, to permit said receiver to receive said predetermined contact-free user input only when made by said one of said users who last made a contact-free user input in said first operating mode.

12. An apparatus as claimed in claim 11 wherein said mode setting unit is configured to activate an additional operating mode of said receiver after detection of at least one of an inactive phase in which no user input is detected, and after detection of an additional predetermined, contact-free user input by said one of said users who previously made said predetermined user input.

13. An apparatus as claimed in claim 12 wherein said mode setting unit is configured to switch said receiver from said additional operating mode into said operating mode upon detection of another predetermined contact-free user input made by any of said users.

14. An apparatus as claimed in claim 11 comprising an alignment that aligns said receiver, and wherein, in said first operating mode, said mode setting unit is configured to control alignment of said receiver device via said alignment unit to align said receiver on one of said users in said first operating mode, and changing alignment of said receiver from said one of said users to another of said users in said first operating mode.

15. An apparatus as claimed in claim 14 wherein said mode setting unit is configured to change alignment of said receiver, via said alignment unit, in said first operating mode from said another of said users back to said one of said users.

16. An apparatus as claimed in claim 14 wherein said mode setting unit is configured to control said alignment of said receiver, via said alignment unit, in a time-dependent manner.

17. An apparatus as claimed in claim 11 comprising an alignment that aligns said receiver, and wherein said mode setting unit is configured to control alignment of said receiver, via said alignment device, to focus said receiver on only one of said users, and to preclude a change of alignment of said receiver off of said one of said users in said second operating mode.

18. An apparatus as claimed in claim 11 comprising an alignment that aligns said receiver, and wherein said mode setting unit is configured to control said receiver, via said alignment unit to align said receiver on no individual one of said users in said first operating mode.

19. An apparatus as claimed in claim 11 wherein said receiver is at least one of a camera, a TOF camera, a head tracker, an eye tracker, and a microphone.

20. An apparatus as claimed in claim 11 wherein said is configured to detect, as said contact-free user inputs, inputs selected from the group consisting of hand gestures, arm gestures, head gestures, eye gestures and speech, and said mode setting unit is configured to interpret said input selected from said group in order to generate said control signals therefrom.

21. An apparatus as claimed in claim 11 wherein said controlled device is a medical device configured to acquire medical data from a patient or implement a medical procedure on a patient.
